(19) United States
(12) Patent Application Publication
(10) Pub. No.: US 2003/0200196 A1
(43) Pub. Date: Oct. 23, 2003

(54) Five elements energy converting system for data element of database

(76) Inventor: E-Chain Cheng, Taichung (TW)

Correspondence Address: VENABLE, BAETJER, HOWARD AND CIVILETTI, LLP, P.O. BOX 34385, WASHINGTON, DC, 20043-9998, US

(21) Appl. No.: 10/448,386

(22) Filed: May 30, 2003

Related U.S. Application Data
(63) Continuation-in-part of application No. 09/668,307, filed on Sep. 25, 2000, now abandoned.

(51) Int. Cl. G06F 7/00

(52) U.S. Cl. 707/1

(57) ABSTRACT

A Five Elements energy converting system has a server, at least one record database connecting to the server and to at least one external database and a conversion module corresponding to each record database to transform each data element in each external database to a Five elements energy code. By such an arrangement, each data element in the external database can be transformed to a Five Elements energy code in addition to being stored in the corresponding record database. Consequently, the correlation and the calculation between the data elements of different databases can be simplified. The time for calculation between different databases can be shortened.

### BACKGROUND OF THE INVENTION

1. Field of the Invention

The present invention relates to a CIP (continuation-in-part) application, and more particularly to a CIP application to the U.S. Ser. No. 09/668,307 patent application.

2. Description of Related Art

A conventional database is composed of a huge amount of data with each data element coded in a desired way. A unique program is needed to make calculations with and correlate the data elements in different databases. However, a unique program to deal with two specific databases cannot be used to deal with other different databases. The data in one database cannot be used to make direct computations and correlation with data elements in a different database, such that the conventional program is limited.

To overcome the shortcomings, the present invention tends to provide a Five Elements energy converting system to mitigate or obviate the aforementioned problems.

### SUMMARY OF THE INVENTION

The main objective of the invention is to provide a Five Elements energy converting system to transform each data element in each external database to a Five Elements energy code. This can simplify the correlation of and the calculation between the data elements of different databases. The Five Elements energy converting system has a server, at least one record database connected to the server, and to at least one external database and a conversion module corresponding to each record database.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a Five Elements energy converting system in accordance with the present invention;

FIG. 2 is an operational diagram of the Five Elements energy converting system in FIG. 1 in use on the Internet;

FIG. 3 is a flow chart of transforming the data elements of human resource database to a Five Elements energy code by the first conversion module in FIG. 1;

FIG. 4 is a flow chart of transforming the data elements of object or finance database to a Five Elements energy code by the second conversion module in FIG. 1;

FIG. 5 is a flow chart of transforming the data elements of knowledge or information database to a Five Elements energy code by the third conversion module in FIG. 1;

FIG. 6 is a flow chart of con-elating two Five Elements energy codes transformed from the input data and data element at a remote database by a correlation module in the Five Elements energy converting system in accordance with the present invention; and

FIG. 7 is a flow chart of an updating process for the Five Elements energy converting system in accordance with the present invention.

### DETAILED DESCRIPTION OF PREFERRED EMBODIMENT

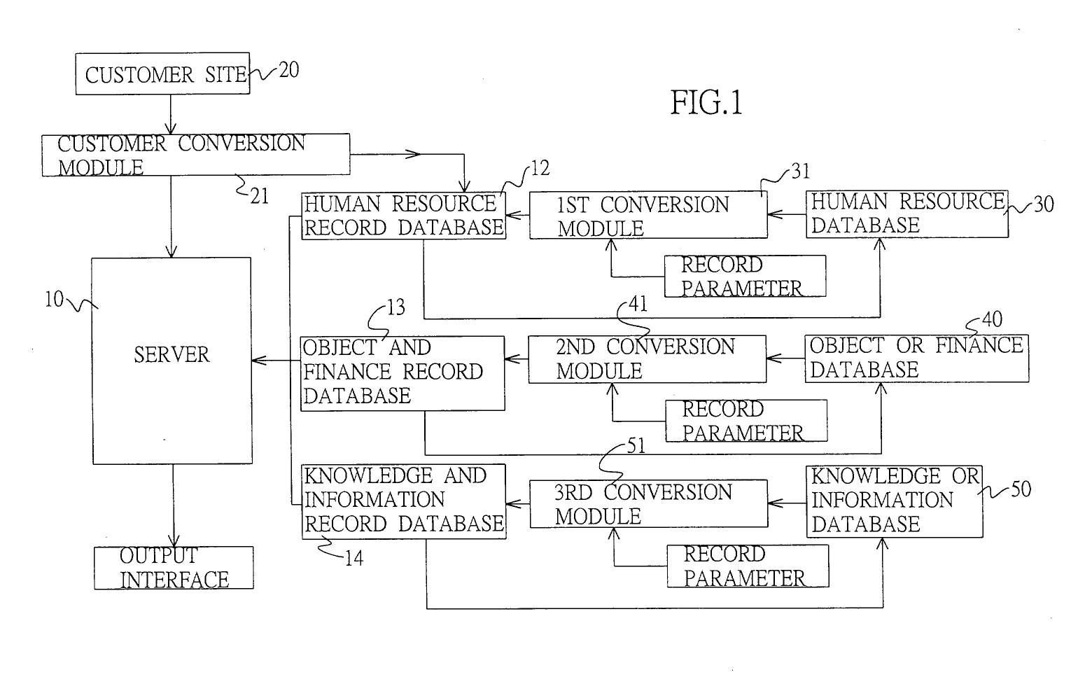

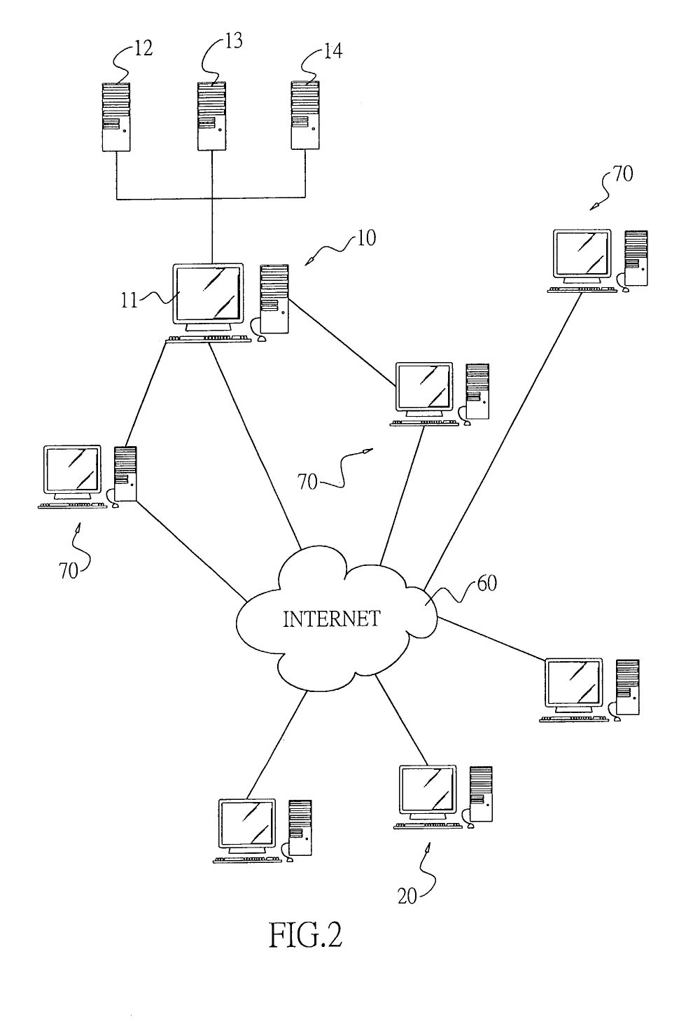

With reference to FIGS. 1 and 2, a Five Elements energy converting system in accordance with the present invention comprises a server (10), at least one conversion module (31,41,51) to transform each data element of a remote database to a corresponding Five Elements energy code, a record database (12,13,14) to store the corresponding codes, and an outer interface to show the calculation result of the system.

The server connects multiple customer sites (20) and service suppliers (70) through the Internet (60). Each service supplier (70) has at least one database to store data and information about products or services provided. The service supplier database could be a human resource database (30) to supply information about human resources, an object database (40) to supply information to sell an object, a finance database (40) to supply financial or investment information, or a knowledge database (50) to supply general information or another information database (50). Accordingly, the record database (12,13,14) could be a human resource record database (12), an object and finance record database (13) or a knowledge and information record database (14). Each conversion module (31,41,51) is used to transform each data element in the corresponding database (30,40,50) to a Five Elements energy code and store the code in the corresponding record database (12,13,14).

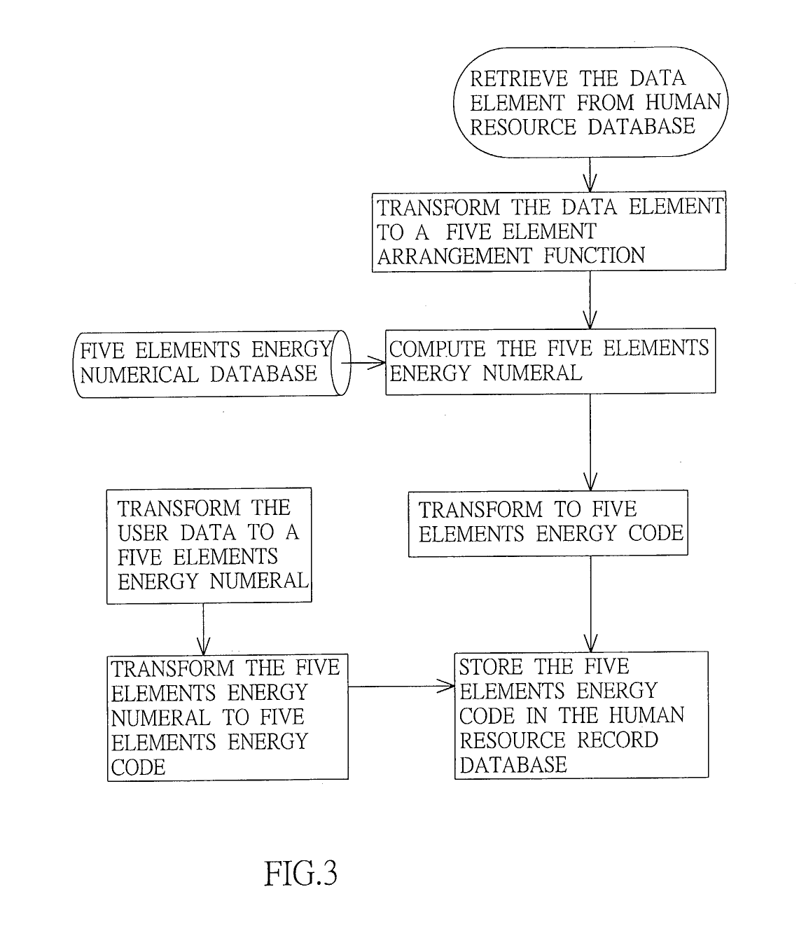

A first conversion module (31) is provided to transform each data element in each of the human resource databases (30) to a corresponding Five Elements energy code. With reference to FIGS. 1 and 3, the first conversion module (31) first transforms each data element in each of the human resource databases (30) to a Five Elements arrangement function based on the name, the birth time, the location or the sex of a person in accordance with the classical Chinese Five Elements Theory. Wherein, the Five Elements arrangement function is a function with varieties of the elements of the Ten Heavenly Stems, the Twelve Earthly Branches and the Five Elements. The Five Elements arrangement function has multiple sub-functions including a Metal-Positive function (referred to as MP), a Metal-Negative function (referred to as MN), a Wood-Positive function (referred to as TP), a Wood-Negative function (referred to as TN), a Water-Positive function (referred to as WP), a Water-Negative function (referred to as WN), a Fire-Positive function (referred to as FP), a Fire-Negative function (referred to as FN), an Earth-Positive function (referred to as EP) and an Earth-Negative function (referred to as EN). Each sub-function has varieties of the elements of the Ten Heavenly Stems, the Twelve Earthly Branches and the Five Elements. For example, the first conversion module (31) transforms the name of a person into the Five Elements arrangement function based on the strokes of the name in Chinese characters. The first conversion module (31) can also transform the year, month and date of birth of a person into the Ten Heavenly Stems and the Twelve Earthly Branches furthermore into the Five Elements arrangement function. A Five Elements arrangement function referring to a person can be transformed in accordance with the person's name, the birth date, the birth place, sex and so on.

The first conversion module (31) then transforms the Five Elements arrangement function to a set of five numerals through a Five Elements energy numerical database, wherein each numeral corresponds to one of the Five Elements. The Five Elements energy numerical database has a number of numerical values. Each numerical value corresponds to one of the elements of the Ten Heavenly Stems, the Twelve Earthly Branches and the Five Elements. Each numerical value in the Five Elements energy numerical database has a predetermined constant and a variable. The initial value of the variable of each numerical can be set to zero. Consequently, the Five Elements arrangement function can be calculated as a set of five numbers from the numeric elements in the database, wherein each number corresponds to one of the Five Elements. Wherein, each number can be a sum of the corresponding sub-functions. For example, the number corresponding to the Wood element can be a sum of the corresponding sub-functions TP and TN. Furthermore, a code corresponds to the weighted ratio of each Five Elements number to the total of the five numbers. Consequently, a Five Elements energy code corresponding to the weighted ratio of each Five Elements number to the total of the five numbers can be given.

For example, if the Five Elements arrangement function computes the five numbers, Wood 63, Fire 83, Metal 72, Earth 64 and Water 48 based on the time of birth of a person, the code for Wood is 19 because the number for Wood 63 over the total 330 is 0.19. In this manner, the code for Fire is 25, the code for Metal is 22, the code for Earth is 19 and the code for Water is 15. Consequently, a specific code is generated with each code of the corresponding element of the Five Elements.

In another embodiment, a code referring to an element of the Five Elements can be achieved by means of averaging the numbers corresponding to the sub-functions referring to the element. For example, a code corresponding to the Wood element is achieved by means of averaging the numbers corresponding to the corresponding sub-functions TP and TN.

In addition, the Five Elements energy analytic module can be used to transform the selecting data into a variable code appended to the specific code.

Consequently, the Five Elements energy code can be achieved by the combination of the specific code transformed from the primary data and the variable code transformed from the selecting data. For example, a “Mr. Chen” born on Jan. 23, 1970 at 12:00 A.M. has a Five Elements energy code 14T21F15E27M23W transformed by the first conversion module (31).

A code developed from the other primary data or the attachment data can be selected to add to the Five Elements energy code. The calculated results of the analysis system can be printed over the user interface in the form of a wave diagram, an energy table or a literal description according to the relationship of the Five Elements theory.

In addition, with reference to FIGS. 1, 2 and 3, the input data input in the customer site (20) by a user can be transformed to a Five Elements energy code through a customer conversion module (21). Wherein, the processes of the customer conversion module (21) are like those of the first conversion module (31). Consequently, the user's data elements also can be transformed to a corresponding Five Elements energy code and stored in the human resource record database (12).

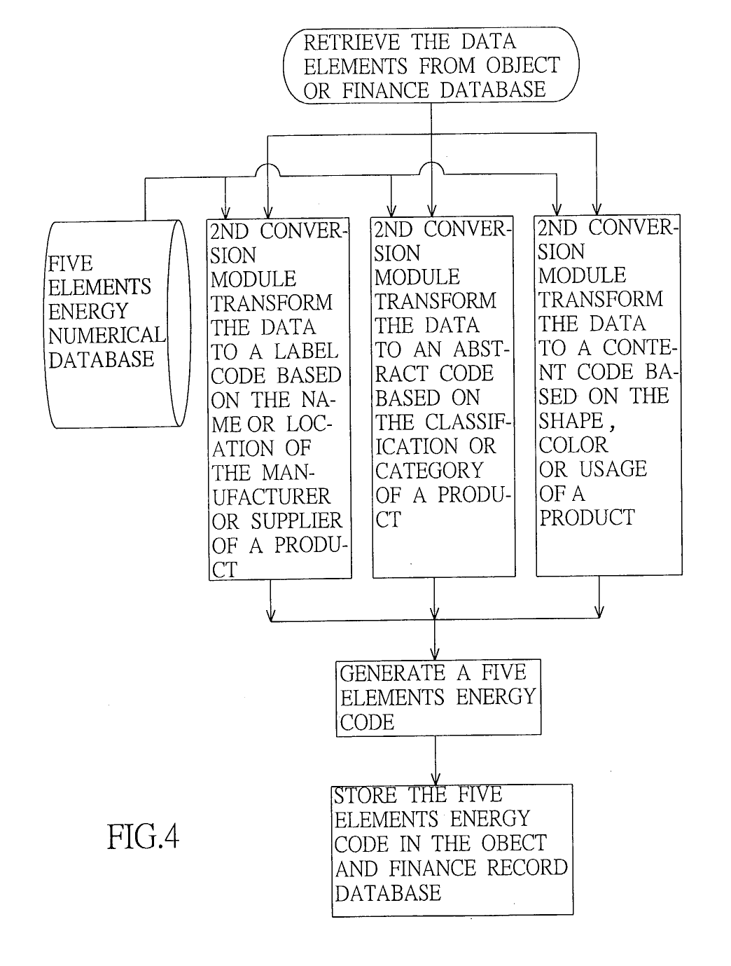

With reference to FIGS. 1 and 4, a second conversion module (41) is provided to transform each data element in each of the object or the finance databases (40) to a corresponding Five Elements energy code. The second conversion module (41) transforms each data element in the object or the finance databases (40) to a Five Elements arrangement function based on the name of the product, the name or the location of the manufacturer or the supplier and so on. The Five Elements arrangement function is then transformed to a Five Elements energy code by means of the numerical values in the Five Elements energy numerical database. Preferably, the Five Elements energy code of each data element of the object or finance databases (40) is divided into a label code, an abstract and a content code. The label code is based on the name or the location of the manufacturer or the supplier of a product. The abstract code is based on the classification or the category of the product. The content code is based on the shape, the color or the use of the product. Consequently, a Five Elements energy code combined with the label code, the abstract code and the content code is achieved, and the combined Five Elements energy code is stored in the object and finance record database (13). For example, an object has a Five Elements energy code 42T23F17E14M04W transformed by the second conversion module (41) in accordance in accordance with the shape, the color or the manufacturer.

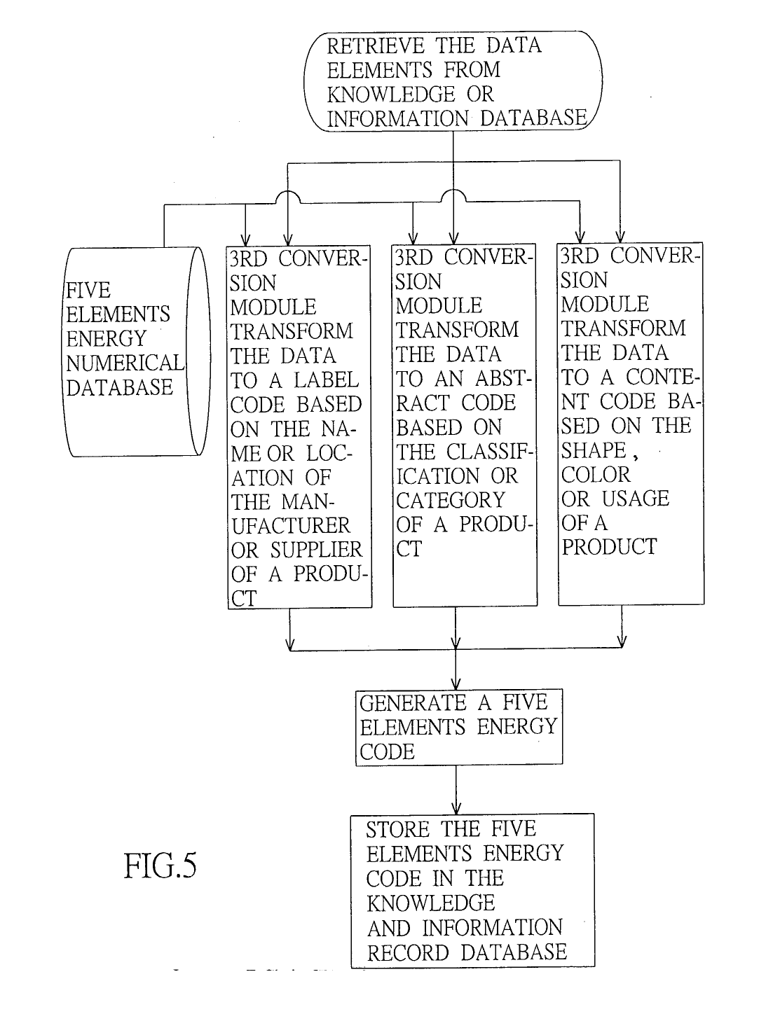

With reference to FIGS. 1 and 5, a third conversion module (51) is provided to transform each data element in each of the knowledge or information databases (50) to a corresponding Five Elements energy code. In a similar manner to the Five Elements energy code in the object and finance record database (13), the third conversion module (51) transforms each data element in the knowledge or information databases (50) to a Five Elements arrangement function with varieties of elements of the Ten Heavenly Stems, the Twelve Earthly Branches and the Five Elements in accordance with the classical Chinese Five Elements Theory. The Five Elements arrangement function is then transformed to a Five Elements energy code through the Five Elements energy numerical database. The Five Elements energy code of each data element of the knowledge or information databases (50) can be divided into a label code, an abstract code and a content code. The label code is based on the name or the location of the manufacturer or the supplier of knowledge or information. The abstract code is based on the classification or the category of the knowledge or information. The content code is based on the shape, the color or the use of the knowledge or information product. A Five Elements energy code combined with the label code, the abstract code and the content code is achieved, and the combined Five Elements energy code is stored in the knowledge and information record database (14).

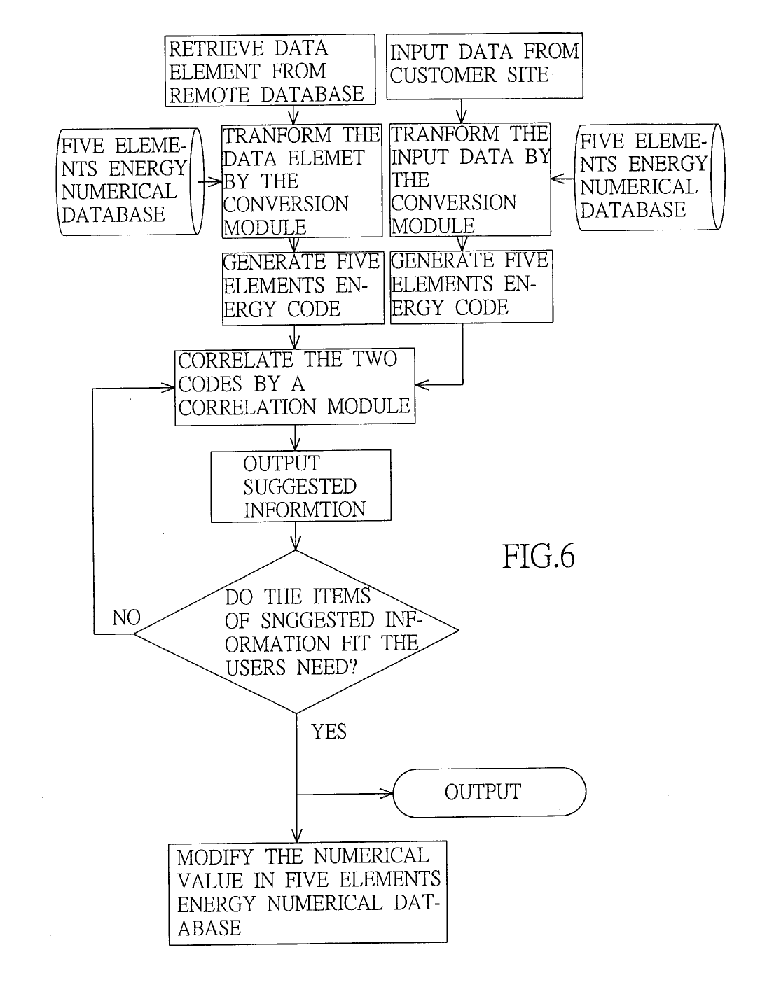

In practice, with reference to FIGS. 1, 2 and 6, the server (10) connects to multiple databases of service supplier and customer sites (20). A conversion module (21,31,41,51) is provided to transform the data elements of each of the remote databases and the customer sites (20) to a corresponding Five Elements energy code. The server (10) further comprises a correlation module to correlation and compute the relationship between data elements of the remote databases and the customer site (20) by means of directly calculating and correlating the Five Elements energy codes of user's data and service supplier's data. Consequently, the correlation and calculation between the data elements of different databases can be simplified and thus, the time needed to make calculations between different databases can be shortened.

In addition, a list of suggested information can be computed by the correlation module and transmitted to the customer site (20). The user at the customer site (20) can select the items of information needed, and decide whether to compute again or not. If the user chooses to compute again, the server (10) will modify the corresponding variable in the Five Elements energy numerical database in accordance with the choice of the user. The corresponding code will be modified by the modified variable. In theory, the next calculation result can fit better the needs of the user. If the items of suggested information fit with the needs of the user, and the user chooses not to compute again the server will output the result to the customer site (20) and inform the corresponding service supplier. In addition, the server (10) can record and analyze the choice of each user to modify the variable of the corresponding numeral element of Five Elements energy numerical database such that the final choice of the user can be considered when the system is in a following operation. Thus, the calculated results of the analysis system will be exact and close to the user's needs.

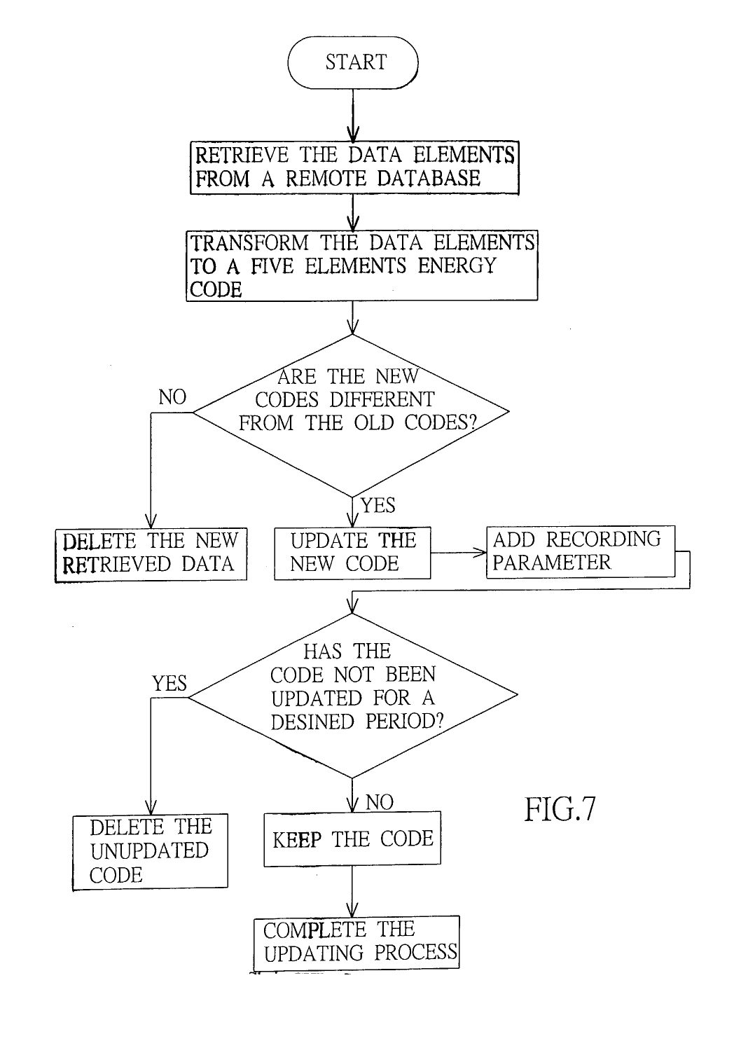

Furthermore, the server has updating means for updating the data elements of the record databases (12,13,14) after a period of time. Referring to FIGS. 1 and 7, the steps of updating comprise:

1. retrieving data elements from the remote database:

The server (10) retrieves the data from the remote database through the Internet.

2. transforming each data element to the corresponding Five Elements energy code:

The server transforms each data element to the Five Elements energy code by the corresponding conversion module.

3. determining whether the new codes are different from the corresponding old codes:

If the answer is “No”, the new codes are deleted. If the answer is “Yes”, the updating process is continued.

4. updating the new data in the record database:

If the new codes are different from the old codes, the old codes are replaced with the new codes. Simultaneously, a record parameter is generated based on the time that the new data is updated, as shown in FIGS. 1 and 7. The record parameter will be appended to the Five Elements energy code, such that a timing control term will be included in each Five Elements energy code.

5. checking to determine whether the data has not been updated for a desired period:

The server will check each code to determine whether it has not been updated during a predetermined period based on the timing parameter. If the answer is “Yes”, it means that the responding data of that code has not been used, updated, manufactured or supplied for a predetermined long time. The unchanged data could have no advantage in being stored in the database. The server will delete a code that has not been updated for a desired long time. If the answer is “No”, the code will be kept.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A Five Elements energy converting system for databases comprising:
a server;
at least one record database connecting to the server and to at least one external database; and
a conversion module corresponding to each record database to transform each data element in each external database to a Five elements energy code.

2. The converting system as claimed in claim 1, wherein the record database is a human resource record database connecting to a human resource database to supply information about human resources;
a first conversion module provided to transform each data element in each of the human resource databases into a Five Elements arrangement function with varieties of elements of the Ten Heavenly Stems, the Twelve Earthly Branches and the Five Elements in accordance with the classical Chinese Five Elements Theory;
a Five Elements energy numerical database with multiple numeric elements to transform the Five Elements arrangement function to Five Elements energy numbers; and
means for transforming the Five Elements energy numbers to a Five Elements energy code.

3. The converting system as claimed in claim 2, wherein the first conversion module transforms each data element in each of the human resource databases into a Five Elements function based on the name, the birth time, the location or the sex of a person.

4. The converting system as claimed in claim 2, wherein each numeric element in the Five Elements energy numerical database has a predetermined value and a variable.

5. The converting system as claimed in claim 4, wherein the initial value of the variable of each numeric element is zero.

6. The converting system as claimed in claim 1, wherein the record database is an object and finance record database connected to at least one object database to supply information about or to sell an object or at least one finance database to supply finance or investment information;
a second conversion module is provided to transform each data element in each of the object or the finance databases to a Five Elements arrangement function with varieties of elements of the Ten Heavenly Stems, the Twelve Earthly Branches and the Five Elements in accordance with the classical Chinese Five Elements Theory;
a Five Elements energy numerical database with multiple numeric elements to transform the Five Elements arrangement function into Five Elements energy numbers; and
means for transforming the Five Elements energy numbers into a Five Elements energy code.

7. The converting system as claimed in claim 6, wherein the second conversion module transforms each data element in each of the object or finance databases into the Five Elements arrangement function based on the name of the product, the name or the location of the manufacturer or the supplier.

8. The converting system as claimed in claim 7, wherein the Five Elements energy code is divided into a label code based on the name or the location of the manufacturer or the supplier of a product, an abstract code based on the classification or the category of the product and a content code based on the shape, the color or the usage of the product.

9. The converting system as claimed in claim 6, wherein each numeric element in the Five Elements energy numerical database has a predetermined value and a variable.

10. The converting system as claimed in claim 9, wherein the initial value of the variable of each numeric element is zero.

11. The converting system as claimed in claim 1, wherein the record database is a knowledge and information record database connected to at least one knowledge database to supply knowledge information or another information database;
a third conversion module is provided to transform each data element in each of the knowledge or information databases into a Five Elements arrangement function with varieties of elements of the Ten Heavenly Stems, the Twelve Earthly Branches and the Five Elements in accordance with the classical Chinese Five Elements Theory;
a Five Elements energy numerical database with multiple numeric elements to transform the Five Elements arrangement function to Five Elements energy numbers; and
means for transforming the Five Elements energy numbers to a Five Elements energy code.

12. The converting system as claimed in claim 11, wherein the third conversion module transforms each data element in each of the knowledge or information databases to a Five Elements arrangement function based on the name of the product, the name or the location of the manufacturer or the supplier.

13. The converting system as claimed in claim 12, wherein the Five Elements energy code is divided into a label code based on the name or the location of the manufacturer or the supplier of a product, an abstract code based on the classification or the category of the product and a content code based on the shape, the color or the usage of the product.

14. The converting system as claimed in claim 11, wherein each numeric element in the Five Elements energy numerical database has a predetermined value and a variable.

15. The converting system as claimed in claim 14, wherein the initial value of the variable of each numeric element is zero.

16. The converting system as claimed in claim 1 further comprising an output interface to show the calculation results of the system.

17. The converting system as claimed in claim 1 further comprising updating means for updating the codes in the record database.

18. The converting system as claimed in claim 17 further comprising a record parameter generated based on the time of updating the new data element and being added to the Five Elements energy code.
